(19) United States
(12) Patent Application Publication
(10) Pub. No.: US 2002/0090171 A1
(43) Pub. Date: Jul. 11, 2002

(54) Integrated optical wavelength division multiplexing using a bench of channel waveguides

(76) Inventors: Demetri Psaltis, Pasadena, CA (US); Christophe Moser, Pasadena, CA (US); Greg Steckman, Pasadena, CA (US); Karsten Buse, Gmhuette (DE); Ingo Nee, Papenburg (DE); Joerg Hukriede, Lengerich (DE)

Correspondence Address: J. D. Harriman II, COUDERT BROTHERS LLP, 23rd Floor, 333 South Hope Street, Los Angeles, CA, 90071, US

(21) Appl. No.: 10/006,935

(22) Filed: Dec. 4, 2001

Related U.S. Application Data
(60) Provisional application No. 60/251,352, filed on Dec. 4, 2000.

(51) Int. Cl. G02B 6/293; G02B 6/34; G02B 6/12

(52) U.S. Cl. 385/24; 385/37; 385/14

(57) ABSTRACT

Embodiments of the present invention are directed to a method and apparatus for integrated optical wavelength division multiplexing using a bench of channel waveguides. In one embodiment, a plurality of waveguides is formed on a single substrate. Different waveguides are constructed to filter different channels carried on a single optical fiber. In one embodiment, optical fibers are attached to the ends of each waveguide. To select a specific filter, the fiber attached to the appropriate waveguide is used. In another embodiment, optical fibers are not attached to the ends of each waveguide. To select a specific filter, the reading head holding the fibers or the waveguide substrate is moved. In another embodiment, a voltage is supplied across the waveguide. Adjusting the voltage also adjusts which channel the waveguide will filter. In one embodiment, a circulator is used to extract the filtered channel.

### RELATED APPLICATION

The applicant claims priority to provisional patent application No. 60/251,352 filed Dec. 4, 2000.

### BACKGROUND OF THE INVENTION

1. Field of the Invention

The present invention relates to the field of optical communications, and in particular to a method and apparatus for integrated optical wavelength division multiplexing using a bench of channel waveguides.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

2. Background Art

With the rapid emergence of the Internet, there is a great need to increase the volume of data (commonly termed bandwidth) that can be transmitted across a network of computing devices. Initially, optical fiber networks carried only a single channel at a single wavelength. The bandwidth of optical fibers was increased by using a scheme known as wavelength division multiplexing (WDM).

The concept of WDM is to launch and retrieve multiple data channels in and out, respectively, of an optical fiber. Prior to the use of WDM, most optical fibers were used to unidirectionally carry only a single data channel at one wavelength. WDM divides a network's bandwidth into channels, with each channel assigned a particular wavelength. This allows multiple channels to be carried on the same transmission medium. For example, multiple optical channels can be transmitted on the same optical fiber. The gain in the network bandwidth is given combining multiple single channel bandwidths. The term “signal” denotes the entire collection of channels, with each channel being transmitted at particular wavelength.

The channels traveling on an optical fiber are multiplexed at a transmitting end and transmitted to a receiving end where they are demultiplexed into individual channels. In the existing systems, the transmitting and receiving ends must be tuned to the same wavelengths to be able to communicate. That is, the transmitting and receiving ends use a device such as an add/drop multiplexer to transmit/receive a fixed channel. In the case of fiber optic cable, an optical add/drop multiplexer is used at the transmitting and receiving ends to generate a fixed wavelength (e.g., using lasers) and to receive a fixed wavelength. For example consider four channels 1, 2, 3 and 4. If the transmitting end is sending via channel 1, the receiving end must tune into channel 1 as well to receive the data. When the transmitting end switches to channel 2, the receiving end must switch as well. Existing systems have as many as 16-100 channels. The different channels have a fixed wavelength spacing, called the ITU grid. However, the fixed nature of the existing implementations are inefficient and expensive to implement.

### SUMMARY OF THE INVENTION

Embodiments of the present invention are directed to a method and apparatus for integrated optical wavelength division multiplexing using a bench of channel waveguides. One embodiment of the present invention provides a cost-effective method of integrating a plurality of waveguides on a single waveguide bench. Different waveguides are constructed, each to filter a particular wavelength. By these means a single waveguide bench can filter a variety of different channels.

A periodic refractive index grating is recorded in each waveguide. The grating period determines which specific channel is filtered out of the incoming signal. The gratings are created using laser light. In one embodiment, two laser beams generate an interference pattern on the waveguide bench. Other embodiments can use more than two laser beams. In another embodiment, a phase mask is used to generate interference patterns. In one embodiment, the gratings of a plurality of waveguides are created simultaneously.

To provide access to the waveguide, fibers are attached to both ends of a waveguide in one embodiment. One fiber carries channels into the waveguide for filtering and another carries away channels that have passed through the waveguide. The incoming signal (including all the channels) is transmitted to each waveguide through its associated fiber. To filter a specific channel, the fiber that is attached to the appropriate waveguide is selected. Using this method of access, a device connected to a system with the bench of waveguides is able to communicate on all channels of the WDM connection. In another embodiment, fibers are not attached to each waveguide. To filter a specific channel out of the incoming signal, a reading device is positioned such that the entire signal passes through the appropriate waveguide. Changing which channel is filtered involves repositioning the reading device and/or the bench of waveguides.

Embodiments of the present invention allow for selection of waveguide to filter out a specific channel. In one embodiment, plane parallel gold electrodes are deposited on both sides along a channel waveguide. A constant voltage is applied to the electrodes. A particular waveguide can be switched to an “on” state or an “off” state by adjusting the voltage across the waveguide. This means: in the “on” state, the waveguide filters its associated channel and in the “off” state the waveguide allows all channels to pass. In one embodiment, the filtered channel is sent back via a circulator to a different fiber.

### BRIEF DESCRIPTION OF THE DRAWINGS

These and other features, aspects and advantages of the present invention will become better understood with regard to the following description, appended claims and accompanying drawings where:

FIG. 1 is a diagram of a substrate in accordance with one embodiment of the present invention.

FIG. 2 is a diagram of a substrate with waveguides in accordance with one embodiment of the present invention.

FIG. 3 is a diagram of the creation of a periodic refractive index grating using two expanded, coherent beams of a laser in accordance with one embodiment of the present invention.

FIG. 4 is a diagram of the creation of a periodic refractive index grating using a phase mask in accordance with one embodiment of the present invention.

FIG. 4A illustrates that a phase mask can be used to create many gratings simultaneously.

FIG. 5 is a flow diagram of the process of creating a bench of waveguides in accordance with one embodiment of the present invention.

FIG. 6 is a diagram of a waveguide wherein the channel filtered by the waveguide is tuned by a voltage in accordance with one embodiment of the present invention.

FIG. 7 is a diagram of a waveguide with a circulator in accordance with one embodiment of the present invention.

FIG. 8 is a flow diagram of the process of switching a filter on a bench of waveguides in accordance with one embodiment of the present invention.

FIG. 9 is a flow diagram of the process of accessing a filter on a bench of waveguides in accordance with one embodiment of the present invention.

FIG. 10 is a flow diagram of the process of accessing a filter on a bench of waveguides in accordance with one embodiment of the present invention.

FIG. 11A shows how a waveguide is accessed in accordance with one embodiment of the present invention.

FIG. 11B shows how a waveguide is accessed in accordance with another embodiment of the present invention.

### DETAILED DESCRIPTION OF THE INVENTION

The invention is a method and apparatus for integrated optical wavelength division multiplexing using a bench of channel waveguides. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

Fabrication of a Bench of Waveguides

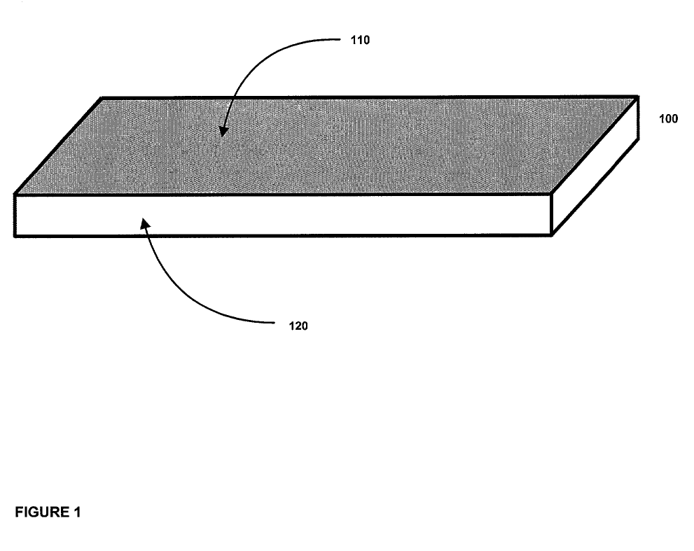

In one embodiment of the present invention, the fabrication of integrated filters involves forming waveguides on a single substrate (termed the “bench”). FIG. 1 illustrates a substrate in accordance with one embodiment of the present invention. Substrate 100 is formed by high temperature indiffusion of impurities 110 (e.g., iron or copper) onto the top of an undoped lithium niobate wafer 120. In various other embodiments, other electrooptical materials such as lithium tantalate are used for the wafer material. The indiffused impurities enhance the photorefractive effect in the material, allowing gratings to be later recorded in the substrate material. Other embodiments use various methods of fabrication to create the waveguide bench.

In one embodiment, the substrate is approximately 0.5 mm to 1 mm in thickness, approximately 20 mm in width and approximately 5 to 20 mm in length (depending on the number of waveguides). In other embodiments, the substrate has other dimensions.

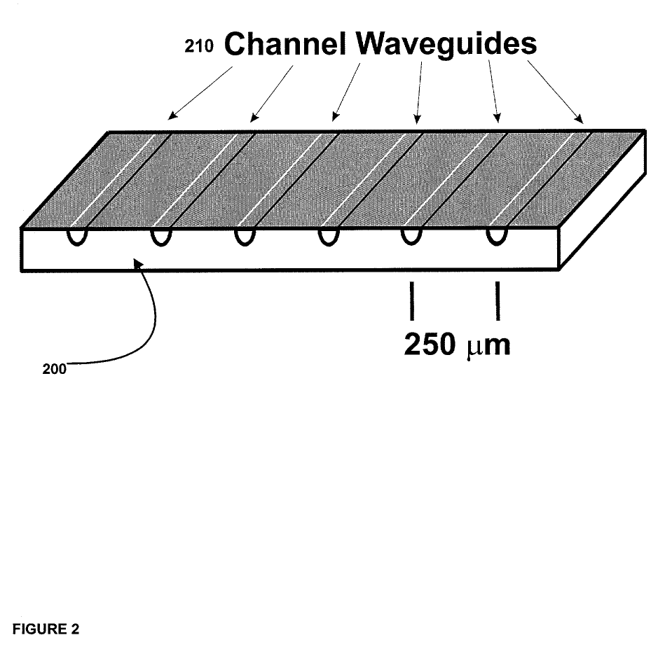

Once the substrate is formed, channel waveguides can be created on it. FIG. 2 illustrates a substrate with channel waveguides in accordance with one embodiment of the present invention. The substrate 200 has a plurality of channel waveguides 210 on the region indiffused with impurities. In one embodiment, thin stripes of titanium are photolithographically defined and indiffused into the substrate to form the waveguides. The refractive index is locally increased and, as a result, light from the incoming fiber is guided by the waveguides. In this embodiment, the distance between waveguides in the substrate is 250 μm. In one embodiment, four parameters are adjusted to create a single mode waveguide in the substrate. These parameters are the thickness of the evaporated titanium layer, the width of the defined stripe, the indiffusion time and the indiffusion temperature.

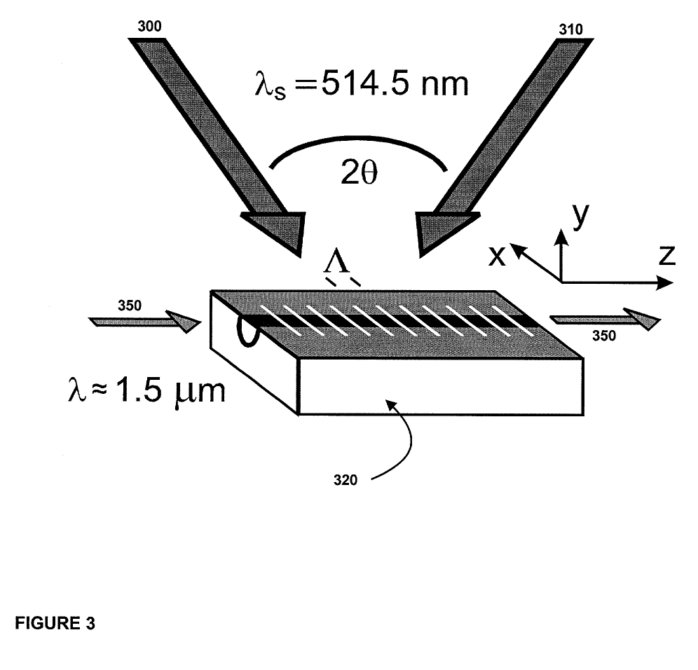

After the formation of the channel waveguides, reflection holograms are recorded into the channels. The recording involves creating periodic refractive index gratings in each waveguide. In one embodiment, the periodic refractive index gratings are created using laser light that creates an interference pattern. FIG. 3 illustrates the creation of a refractive index Bragg grating using two expanded, coherent beams of a laser on a single waveguide channel according to one embodiment of the present invention. Note that the orientation of the waveguide is depicted by the X-Y-Z axis indicator and is turned 90 degrees from FIGS. 1 and 2. A first beam 300 and a second beam 310 are at an angle of 2θ to each other and impinge onto the top surface of the substrate 320 to create an interference pattern. The lines across the waveguide denote the grating period of this grating. The K-vector of the interference pattern is directed along the indiffused channel waveguides. The grating has a period of Λ. The size of Λ determines the wavelength of the channel (denoted by arrows 350) reflected by the waveguide. In this embodiment, the waveguide filters channels with wavelengths approximately equal to 1.5 μm. In one embodiment, various gratings are recorded simultaneously in the bench. This is done by reflecting laser beams from two different mirror stacks. The mirror stacks generate a variety of beams impinging on the substrate under the various angles 2θ.

Light beams 300 and 310 have a wavelength of 514.5 nm, but other embodiments use other wavelengths. The wavelength of the light is chosen to fit to the appropriate absorption band of the indiffused impurity. The grating is created when the generated light interference patterns redistribute charge carriers in each channel waveguide. A space charge field builds up and modulates the refractive index via the electrooptic effect. Permanent gratings are obtained by applying the technique of thermal fixing, if the substrate material is lithium niobate or lithium tantalate. This involves heating up the substrate to elevated temperatures around 180° C. during or after recording of the gratings. After cooling down to room temperature, a development process with light is applied.

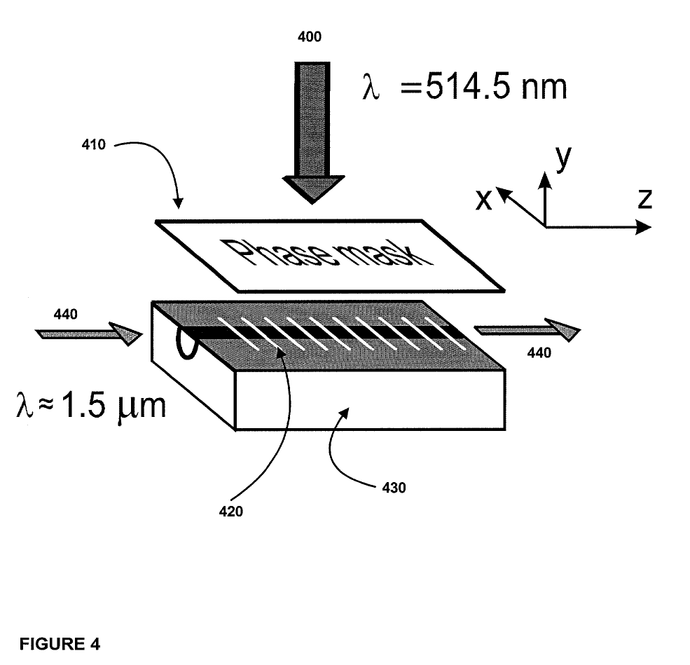

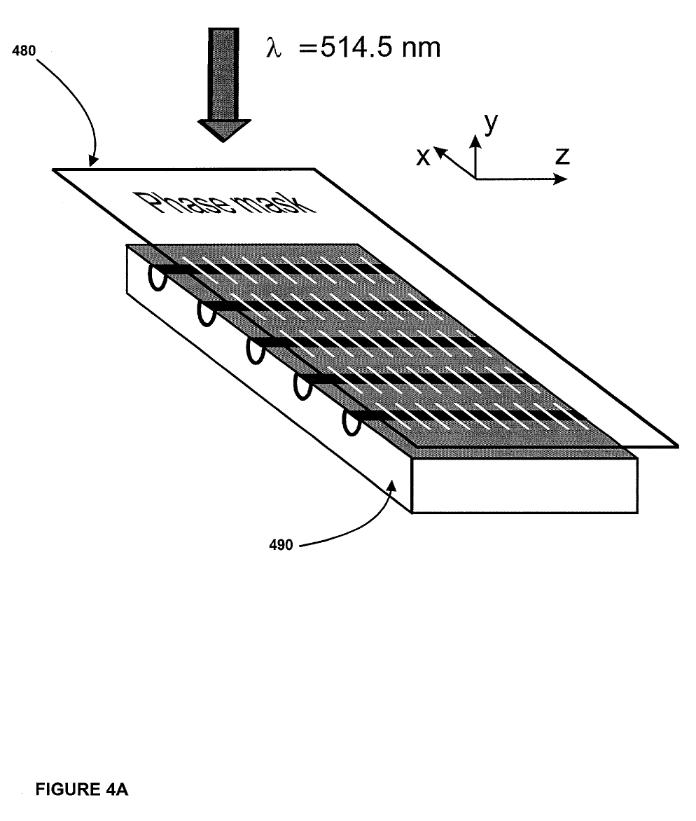

In another embodiment, a phase mask is used to create the refractive index Bragg gratings. In one embodiment, the gratings for a plurality of waveguides are created simultaneously. FIG. 4 illustrates the creation of a refractive index Bragg grating using a phase mask in a single waveguide according to one embodiment of the present invention. The orientation of the waveguide is the same as FIG. 3 and is turned 90 degrees from FIGS. 1 and 2. A laser beam 400 is directed through a phase mask 410 to create grating 420 across waveguide 430. Laser beam 400 has a wavelength of 514.5 nm, but other embodiments use other wavelengths. Grating 420 has a period that determines the wavelength of the channel 440 reflected by the waveguide. In this embodiment, the waveguide filters channels with wavelengths approximately equal to 1.5 μm. FIG. 4A shows how the method of recording allows a variety of gratings to be recorded on a bench simultaneously. In the figure, the laser beam passes through phase mask 480, which allows multiple gratings (denoted by white stripes) to be recorded simultaneously on waveguide bench 490.

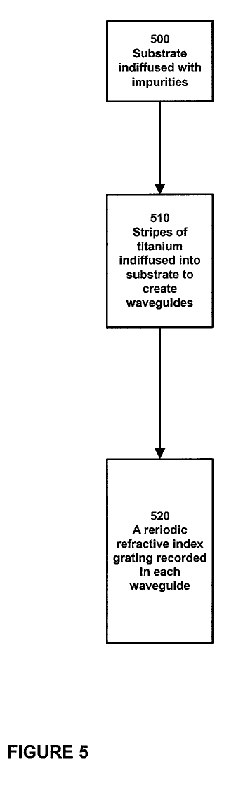

FIG. 5 illustrates the overall process of creating a bench of waveguides in accordance with one embodiment of the present invention. At block 500, a substrate is indiffused with impurities. At block 510, stripes of titanium are indiffused into the substrate to create the waveguides. At block 520, a periodic refractive index grating is recorded in each waveguide.

Voltage Tuning of Waveguides

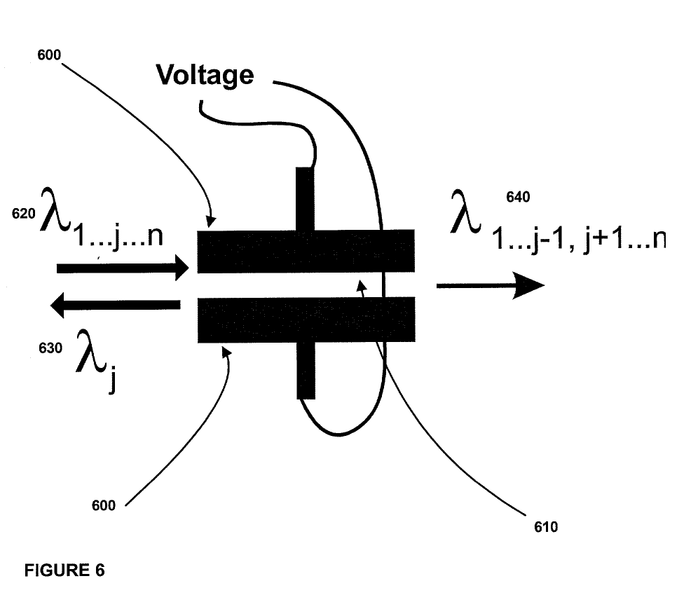

In another embodiment, each channel waveguide can be turned on or off by a voltage that is supplied across the waveguide. FIG. 6 illustrates a waveguide wherein the channel filtered by the waveguide is tuned by a voltage in accordance with one embodiment of the present invention. Plane-parallel gold electrodes 600 are deposited on both sides along a waveguide 610. In other embodiments, different methods to create electrodes may be used. By applying a voltage to the electrodes, the center wavelength of the grating is changed. In the “on” state, the center wavelength is adjusted so that it is present for the channel that is to be filtered. This specific channel in the signal is reflected in the waveguide, filtering it out of transmitted signal. In the “off” state, the center wavelength is adjusted so that all channels in the incoming signal pass through the waveguide. FIG. 6 depicts the operation in the “on” state. All channels 620 in the signal are sent to the waveguide. The filtered channel 630 is reflected back, and the remaining channels 640 continue through the waveguide.

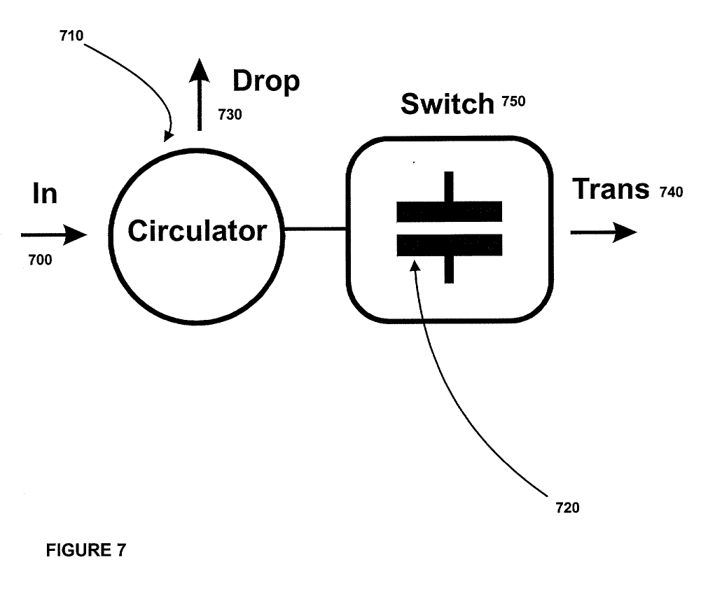

In one embodiment of the present invention, a circulator is used to extract the filtered channel. FIG. 7 illustrates a waveguide with a circulator in accordance with one embodiment of the present invention. The entire signal 700 is passed through a circulator 710 to the waveguide filtering system 720. The filtered channel is reflected back to the circulator and emerges as the drop channel 730. The remaining channels 740 continue on through a transmitting fiber. Using switch 750 to control the voltage across the waveguides, a selected channel can be extracted via electrical switching. The described embodiments may be combined to fabricate more complex integrated optical devices. It is straight forward to create a waveguide bench of 40 channels or more and to switch all of them via an applied voltage, meaning that each of the channels can be switched on or off separately.

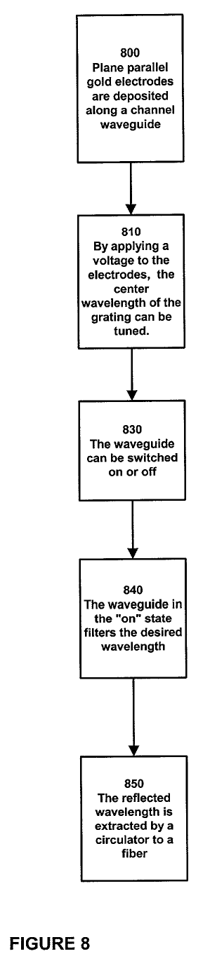

FIG. 8 illustrates the process of electrical switching of a waveguide channel. At block 800, plane parallel gold electrodes are deposited along a channel waveguide. At block 810 a constant voltage is applied to the electrodes to tune the center wavelength of the grating. The waveguide can be switched on or off, as shown in block 830. Block 840 shows that the waveguide, in the “on” state, filters the desired channel. At block 850, the reflected channel is extracted by a circulator to a fiber.

Access of a Particular Channel Waveguide

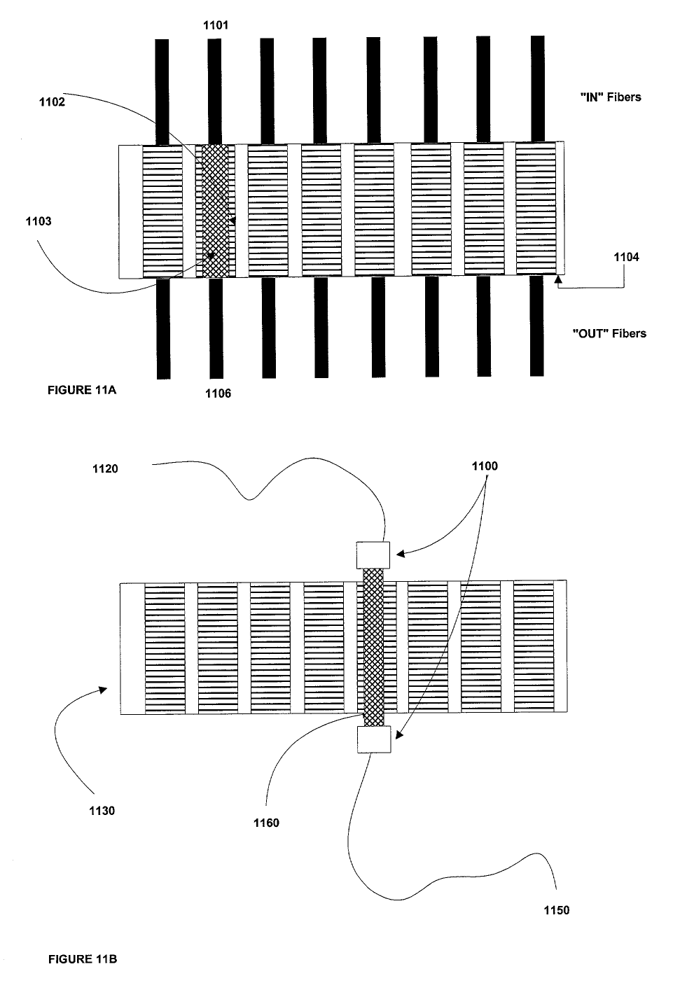

Each waveguide is constructed to filter out a channel out of the many carried by the incoming fiber. FIG. 11A shows an embodiment of the present invention that has mechanisms to access the proper waveguide to filter a selected channel. In this embodiment, fibers are attached to the ends of each waveguide. One fiber is attached to the “IN” end to carry light to the waveguide and another fiber is attached to the “OUT” end to carry light that has passed through the waveguide. To select a specific channel to be filtered, the fiber attached to the “IN” end of the appropriate waveguide is used. In the figure, “IN” fiber 1101 is used to send signal light 1103 through waveguide 1102 on bench 1104. The waveguides in this figure go from top to bottom. Each waveguide contains a grating period, which is illustrated by the horizontal lines going from left to right. Signal light 1103 is represented by the crossing pattern. An “OUT” fiber 1106 collects the light on the other end of the bench. Changing which channel is filtered involves changing which attached fiber is read. As a result, a device connected to a system with a bench of waveguides is able to communicate on all channels of the WDM connection.

In another embodiment, different single mode fibers for the input and the output face are permanently attached to the channel waveguides. Therefore, one makes use of standard silicon-etched V-grooves that support the bare fibers ends. The two silicon bars are attached to the substrate with UV-cure or epoxy. Other methods of attaching fibers to waveguides are also possible.

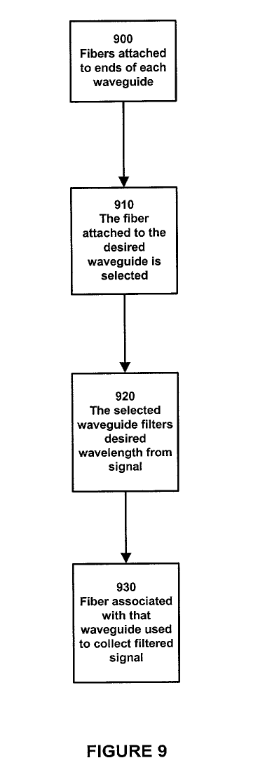

FIG. 9 illustrates the process of accessing a waveguide on a bench of waveguides in accordance with one embodiment of the present invention. At block 900, a fiber is attached to the ends of each waveguide. The incoming signal runs into these fibers to the substrate. At block 910, the fiber that is attached to the desired waveguide is selected. At block 920, the selected waveguide filters the desired channel from the signal. At block 930, a fiber associated with that waveguide is used to collect the filtered signal on the other end of the waveguide.

In other embodiments, fibers are not attached to each waveguide. To select a specific filtered channel, a reading device is positioned such that the signal passes through the appropriate waveguide. FIG. 11B shows such an embodiment. An input fiber 1120 is attached to reading device 1100, which passes the signal light 1160 through a specific waveguide on bench 1130. The waveguides in this figure go from top to bottom. Each waveguide contains a grating period, which is illustrated by the horizontal lines going from left to right. The output fiber 1150 collects the signal on the other end of the bench. In one embodiment, the reading device is movable and selects the appropriate waveguide. Changing which channel is filtered involves moving the reading device relative to the bench of waveguides. In another embodiment, the bench of waveguides is movable. Changing which channel is filtered involves moving the bench of waveguides relative to the reading device. Such a reading device is described in further details in co-pending U.S. patent application Titled “Method and Apparatus For Implementing a Multi-Channel Tunable Filter”, Ser. No. ______, filed Dec. 4, 2001 and assigned to the assignees of this patent application.

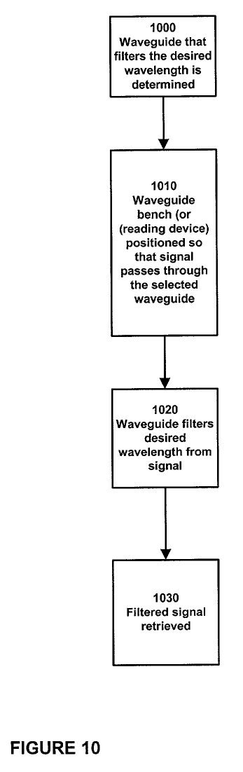

FIG. 10 illustrates the process of accessing a filter on a bench of waveguides in accordance with one embodiment of the present invention. At block 1000, the waveguide that filters the desired channel is selected. At block 1010, the waveguide bench (or the reading device) is positioned so that the signal passes through the selected waveguide. At block 1020, the waveguide filters the desired channel from the signal. At block 1030, the filtered channel is retrieved.

Thus, a method and apparatus for integrated optical wavelength division multiplexing using a bench of channel waveguides is described in conjunction with one or more specific embodiments. The invention is defined by the following claims and their full scope and equivalents.

1. A method of integrated optical wavelength division multiplexing comprising:
forming waveguides on a substrate;
selecting a first waveguide wherein said first
waveguide filters a desired channel; and filtering a channel using said first waveguide.

2. The method of claim 1 wherein said step of forming comprises: indiffusing said substrate with an impurity.

3. The method of claim 2 wherein said impurity is iron.

4. The method of claim 2 wherein said impurity is copper.

5. The method of claim 1 wherein said substrate is lithium niobate.

6. The method of claim 1 wherein said substrate is lithium tantalate.

7. The method of claim 1 wherein said step of forming further comprises:
indiffusing stripes of titanium into said substrate.

8. The method of claim 1 wherein said step of forming comprises:
recording a periodic refractive index grating in each of said waveguides.

9. The method of claim 8 wherein said step of recording comprises:
creating an interference pattern using two expanded, coherent laser beams.

10. The method of claim 8 wherein said step of recording comprises:
creating an interference pattern using two or more laser beams.

11. The method of claim 8 wherein said step of recording comprises:
using a phase mask.

12. The method of claim 11 wherein only said phase mask is needed to record a plurality of gratings.

13. The method of claim 1 wherein said step of selecting comprises:
affixing an optical fiber to each of said waveguides; and
selecting a first optical fiber attached to said first waveguide.

14. The method of claim 1 wherein said step of selecting comprises:
connecting an optical fiber to a reading device;
positioning said reading device to select said first waveguide in said substrate.

15 The method of claim 14 wherein said step of positioning further comprises:
positioning said substrate relative to said reading device to select said first waveguide.

16. The method of claim 1 wherein said step of filtering comprises:
reflecting said desired channel.

17. The method of claim 16 wherein said step of filtering further comprises:
positioning electrodes along said waveguides;
applying a voltage to said electrodes; and
switching said first waveguide to an “on” state or an “off” state.

18. The method of claim 17 wherein said step of positioning electrodes comprises depositing plane parallel gold electrodes along said waveguides.

19. The method of claim 16 wherein said step of filtering further comprises:
retrieving said desired channel using a circulator.

20. An integrated optical wavelength division multiplexing system comprising:
a substrate;
waveguides on said substrate;
a selection unit configured to select a first waveguide wherein said first waveguide filters a desired channel; and
a signal filtering system configured to filter out a channel using said first waveguide.

21. The integrated optical wavelength division multiplexing system of claim 20 wherein said substrate is indiffused with an impurity.

22. The integrated optical wavelength division multiplexing system of claim 21 wherein said impurity is iron.

23. The integrated optical wavelength division multiplexing system of claim 21 wherein said impurity is copper.

24. The integrated optical wavelength division multiplexing system of claim 20 wherein said substrate is lithium niobate.

25. The integrated optical wavelength division multiplexing system of claim 20 wherein said substrate is lithium tantalate.

26. The integrated optical wavelength division multiplexing system of claim 20 wherein said waveguides are formed by indiffusing stripes of titanium into said substrate.

27. The integrated optical wavelength division multiplexing system of claim 20 further comprising:
a recording device configured to record periodic refractive index gratings in said waveguides.

28. The integrated optical wavelength division multiplexing system of claim 27 wherein said recording device comprises:
an interference pattern creation unit configured to create an interference pattern using two expanded, coherent laser beams.

29. The integrated optical wavelength division multiplexing system of claim 27 wherein said recording device comprises:
an interference pattern creation unit configured to create an interference pattern using two or more laser beams.

30. The integrated optical wavelength division multiplexing system of claim 27 wherein said recording device records said gratings using a phase mask.

31. The integrated optical wavelength division multiplexing system of claim 30 wherein only said phase mask is needed to record a plurality of gratings.

32. The integrated optical wavelength division multiplexing system of claim 20 wherein said selection unit comprises:
an optical fiber affixed to each of said waveguides; and
a second selection unit configured to select a first optical fiber affixed to said first waveguide.

33. The integrated optical wavelength division multiplexing system of claim 20 wherein said selection unit comprises:
an optical fiber connected to a reading device wherein said reading device is positioned to select said first waveguide in said substrate.

34. The integrated optical wavelength division multiplexing system of claim 33 wherein said substrate is positioned relative to said reading device to select said first waveguide.

35. The integrated optical wavelength division multiplexing system of claim 20 wherein said signal filtering system comprises:
a reflection system configured to reflect said desired channel.

36. The integrated optical wavelength division multiplexing system of claim 35 wherein said signal filtering system further comprises:
electrodes positioned along said waveguides;
a voltage application system configured to apply a voltage to said electrodes;
a switching mechanism to turn said first waveguide to an “on” state or an “off” state.

37. The integrated optical wavelength division multiplexing system of claim 36 wherein said electrodes are plane parallel gold electrodes deposited along said waveguides.

38. The integrated optical wavelength division multiplexing system of claim 35 wherein said signal filtering system further comprises:
a retrieval unit configured to retrieve said desired channel using a circulator.
